(19) United States
(12) Patent Application Publication
(10) Pub. No.: US 2015/0302067 A1
(43) Pub. Date: Oct. 22, 2015

(54) AN ASSET HANDLING TOOL FOR FILM PRE-PRODUCTION

(71) Applicant: THOMSON LICENSING, Issy-les-Moulineaux (FR)

(72) Inventors: Marc ELUARD, Saint-Malo (FR); Yves MAETZ, Melesse (FR)

(73) Assignee: THOMAS LICENSING, Issy de Moulineaux (FR)

(21) Appl. No.: 14/651,417

(22) PCT Filed: Dec. 9, 2013
(86) PCT No.: PCT/EP2013/075920

§ 371 Date: Jun. 11, 2015

(30) Foreign Application Priority Data
Dec. 13, 2012 (EP) 12306581.5

(51) Int. Cl. G06F 17/30; G06F 3/0482

(52) U.S. Cl. CPC G06F 17/30554; G06F 17/30958; G06F 3/0482

(57) ABSTRACT

An asset handling tool for pre-production of a film having a script configured to: obtain a search expression from a scene of the script; send to an asset database a query for assets corresponding to the search expression; receive a set of assets matching the search expression; display at least part of the set of assets to a user; receive, from the user, a selection of an asset in the set of assets; and link the selected asset with the scene. The asset handling tool is advantageously implemented in a tool for collaborative pre-preproduction of the film and can help a director or a producer to pre-produce the film by suggesting already made assets that can be imported into the film, possibly after treatment.

### TECHNICAL FIELD

The present invention relates generally to film-making and in particular to a pre-production tool for handling assets to include in the film.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Up until recently, film-making was the area where film studios or other kinds of production companies essentially handled the major, if not the whole, process from idea to release. A studio could for example buy the rights to a script (or a story, perhaps from a book), rework the script, plan the production (pre-production), shoot the film, take it through post-production and then distribute it.

Among these steps, pre-production is very important since it, broadly speaking, breaks the script down into smaller elements (shots), defines how the shots are to be made (live shooting, pure CGI, mix of both) and the composition of the shots, but also multiple requirements such as shooting location, accessories, crew and material. A production schedule defines in detail the resources needed for each scene. The resources may be any kind of resource from a vast list comprising for example actors, cameramen, grips, foley artists, hairdressers, animal trainers, catering, stuntmen, set security and permits (e.g. to be able to close off a street for shooting).

During the major part of the history of film-making, pre-production has been performed by the film studio, that perhaps outsourced specific parts of the process, all the while under the supervision of the producer who among other things is in charge of making sure that the budget is respected. Usually, the producer imposes some decisions; a deal may for example be done with a country or a city that wishes to be featured in the film and in return offers subsidies of various kinds.

It will be appreciated that the studios have the necessary expertise to handle the pre-production and that they have internal methods to respect. However, an interesting trend, often named collaborative film-making, has emerged over the last years. It involves often physically distant participants to contribute to making a movie via the Internet. The collaboration can cover several aspects of traditional filmmaking: funding by bringing in at least part of the budget, participation in script writing, proposal of shooting locations, voting during actor casting, or even post-production tasks like audio dubbing or subtitling in a specific language.

As collaborative film-making becomes more wide-spread, there will be a greater demand for tools that allow and support collaborative pre-production. For one thing, a small, independent production is likely to lack the expertise of a studio and, for another, a collaborative effort may bring in people from all over the globe in an ad hoc team. It goes without saying that it is desired to have these people work together in an efficient manner.

Some multiuser tools exist—5th Kind, Scenios, Lightspeed EPS, AFrame, Celtix—but they only partially cover the needs for collaborative film-making. Even though they do use the terminology and organisation typical in the film industry, most of them are mainly to be seen as tools for storing and sharing different files.

It is well known that during the filmmaking process, more assets (shots etc.) are produced than what is used in the final release (or extended cuts) of the movie. As a consequence, for one produced movie, typically more than 50 hours of the generated video is never used. Some of these shots are of course highly specific for the movie, but plenty of shots are more generic and could be reused in another movie. This is particularly true for the so-called “establishing” shots that are inserted to provide some context. Typical examples are a flight over a city or a shot of the main hall of Grand Central Station to situate geographically the location where the action takes place. Reusing such assets may be a very cost-efficient solution when other films are made.

In addition, with the continuous progress in computation power and particularly graphics processing units, more and more computer generated imagery (CGI) techniques are used in filmmaking in different ways: insertion of virtual elements in live shooting, addition of visual effects (fog, fire, etc), compositing of live shooting on greenscreen background with CGI generated sequences or other shooting. However, not all directors, especially beginners, are familiar or comfortable with these techniques.

It will thus be appreciated that there is a need for a solution that can provide a tool for efficient pre-production that can facilitate the production by handling and recommending existing assets to be re-used in the movie. The present invention provides such a solution.

### SUMMARY OF INVENTION

In a first aspect, the invention is directed to an asset handling tool for pre-production of a film having a script. The asset handling tool is implemented using at least one processor configured to: obtain an expression from a scene of the script; send to an asset database a query for assets corresponding to the expression; receive a set of assets matching the expression; display at least part of the set of assets to a user; receive, from the user, a selection of an asset in the set of assets; and link the selected asset with the expression.

In a first embodiment, the processor is configured to link the selected asset and the expression indirectly by associating the expression with an anchor, the anchor being liable to be linked with a plurality of expressions, and by associating the anchor with the selected asset. It is advantageous that the processor is further configured to split an anchor associated with a plurality of expressions into two anchors, each associated with a subset of these expressions,

In a second embodiment, the processor is further configured to analyze the script for the scene to extract information and to include the extracted information in the query; wherein the information comprises at least one of: location information, context information, and a variable deduced from the script, the deduced variable comprising the length of a scene. It is advantageous that the processor is further configured to analyze assets already associated with an anchor to deduce common information and to include the common information in the query. It is also advantageous that the processor is further configured to analyze expressions already associated with an anchor to deduce common information and to include the common information in the query.

In a third embodiment, the selection received from the user is for a plurality of assets.

In a fourth embodiment, the processor is further configured to include information on already chosen assets and indicate that the query is for assets similar to the chosen assets.

In a fifth embodiment, the processor is further configured to include asset parameters in the query, the asset parameters comprising at least one of: type of asset, quality, compositing purpose, camera parameters, format, duration, ambiance or mood, price, lighting, colours and texture.

In a sixth embodiment, the processor is further configured to display an asset when its corresponding expression is displayed to the user. It is advantageous that the processor is further configured to display an asset only when its corresponding expression has been selected by the user.

### BRIEF DESCRIPTION OF DRAWINGS

Preferred features of the present invention will now be described, by way of non-limiting example, with reference to the accompanying drawings, in which

FIG. 1 illustrates the functional aspects of a pre-production tool according to a preferred embodiment of the present invention;

FIG. 2 illustrates an example of use of the pre-production tool; and

FIG. 3 illustrates the features of the pre-production tool in conjunction with an exemplary use case according to a preferred embodiment of the present invention.

### DESCRIPTION OF EMBODIMENTS

The present invention will be described using an example involving four parties—a writer, a director, a producer and a Computer-Generated Imagery (CGI) artist—collaborating using a pre-production tool. It should however be understood that this is just an example and that the present invention can extend to more parties.

For the purposes of the present invention the first input to the pre-production tool is the script, written by the writer. During pre-production, the script may be changed, for example by removing or reordering scenes, amending dialogs or changing the setting of one or more scenes.

As is well known, a script is usually written in a standard format as a sequence of scenes. Each scene has a heading that sets the location and a scene number, after which follows a description of what happens in the scene and any dialog. An example would be:
INT. FLORA'S KITCHEN—MORNING 117
Flora walks into the kitchen and finds her son Sebastian at the table, waiting for her. He is obviously hungry.
   SEBASTIAN
   Mum, do we have any bangers?

During pre-production, the script is broken down, which not only means taking decisions about how the scene will be made—for example, on location, in a studio or using chroma key compositing—but also communicating and documenting the decisions. The present invention provides the possibility to produce project related information digitally using the tool that advantageously is implemented online and to which access may be had through a standard web browser to enable remote use of the tool.

Preferably, the tool is not only available to the parties that participate actively in the pre-production (writer, director, producer, CGI artist) but also to other participants in the project (actors, Visual Effects (VFX) specialists, etc.) since this can allow everyone to share the director's vision of the movie. It is also preferred that only the active parties can input or modify data, and that each party's tool is adapted to the needs of the party; the writer does not have the same needs as the producer or the CGI artist.

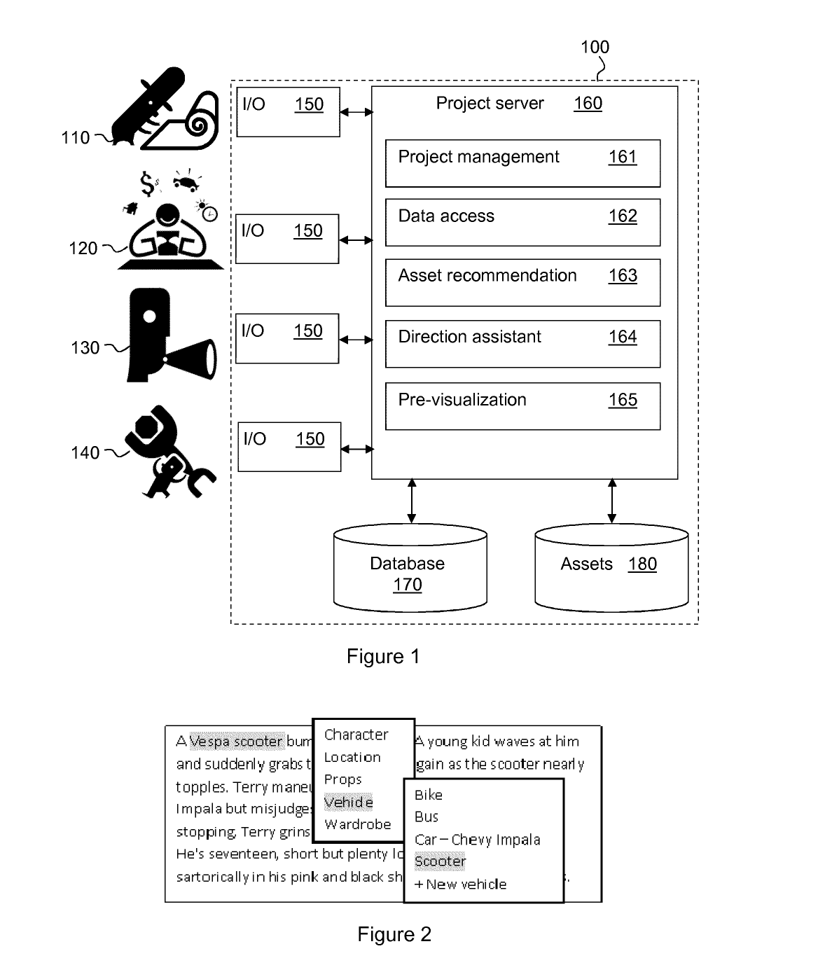

FIG. 1 illustrates the functional aspects of the pre-production tool 100 according to a preferred embodiment of the present invention. The tool 100 comprises interfaces 150, preferably web browsers (but different parties may use different interfaces), through which the writer 110, the producer 120, the director 130 and the CGI artist 140 have separate, independent access to a project server 160. The tool 100 further comprises, connected to the project server 160, a project database 170 configured to store data (such as the relations between the script elements and the assets but also the list of participants, the task schedule, etc.) for the project and an asset database 180 that may be external. The project server 160 comprises a number of modules: a project management module 161, a data access module 162, an asset recommendation module 163, a direction assistant module 164 and a pre-visualization module 165.

The asset recommendation module 163 is configured to analyze the script for keywords, usually for a specific scene, in order to recommend assets. The analysis can be manual or automatic (or a mix thereof where a user validates automated suggestions for keywords).

While it is possible to link keywords directly to assets, it is preferred to introduce a layer of abstraction. To this end, the concept of “anchor” is introduced. An anchor has a unique name throughout the script, e.g. “Aston Martin DB5” or “Vespa Scooter”. One or more keywords may then be an “alias” that is creating a link between a particular element in a script and the anchor. Advantages of the abstraction is that the script may comprise the words “Billy's car” as alias for which the anchor can be changed easily, while, at the same time, two different aliases may share an anchor, for instance if they are different instances of the same car model. At the same time, the same keywords in different scenes may be linked to different anchors, for example if one instance refers to a car driving normally and the other instance refers to the same car, but during or after an accident.

Naturally, further operations are possible, such as merging two anchors if they, as mentioned, refer to the same car model or splitting an anchor if it is desired to specify that the objects referred to are different (e.g. by brand, model, colour or a combination of these).

The asset recommendation module 163 may also comprise a mechanism that helps in the choice of the anchor. Typically, after selecting an alias (i.e. one or more keywords in the script) that is to be associated to an anchor, the mechanism searches for the words of the alias among the names of the anchors, in the aliases bound to anchor and in keywords that represents the set of assets bounded to this anchor. Thus, the mechanism recommends a set of assets for those words through the use of a particular anchor. If the system does not find anything, or if the user believes that what is proposed is not corresponding to the underlying concept, the system can initiate a search in database using words selected by the user as initial values. This mechanism can be used for adding an asset to an anchor. The system can initiate a search using keywords which represents the assets already linked to the anchor. For example, it is possible to use the common keywords to all assets already selected in the anchor or use any inference technique to produce those initial values.

Moreover, to reflect higher-level concepts inherent to scripts and to the world of production, it is possible to use types with anchors. Non-limitative examples of types are: character, location, props, vehicle, and wardrobe. In this case, the more generic anchor types can be used instead of (or in addition to) a more specific anchor.

In one example of implementation, illustrated in FIG. 2, it is assumed that a user is working on a remake of “American Graffiti” based on the original screenplay. The user selects the string “Vespa Scooter”, and right-clicks to open a popup menu that allows tagging the string with the appropriate anchor types, i.e. “Vehicle” in the example. If at least one anchor already exists for the chosen type, then a list of anchors is proposed. This allows the user to choose in this list, which can prevent typing errors. “Vespa scooter” becomes an alias for the anchor “Scooter”. The operation is repeated for each significant element of the hundred pages of the script, resulting in a potentially huge number of elements. After this process, most of the elements needed for the production phase are identified.

An asset may be film scenes that have been shot previously but that were never used in a film, but can also be of other kinds such as audio, photos, 3D models. If, for example, the script states that the scene takes place close to the Eiffel Tower, then the asset recommendation module 163 is configured to search the asset database 180 for assets that are tagged “Eiffel Tower”. Further keywords may be used to narrow the search, for example “night”, “winter”, “rain” and “scary”. The director or the producer may then chose an asset for the scene in question. The recommendation module preferably also takes into account contextual parameters like the ones provided in the script scene title where the location and the moment of the day are provided. When this title specifies that the scene is in PARIS and at NIGHT, the recommendation module will not propose assets related to the Eiffel Tower in Las Vegas or China, nor will it propose elements that are not nocturnal.

As already described, the example involves four users. The first user is the writer 110 whose main task is to provide the script. The second user is the director 130 who usually is the most active party, performing most of the operations and working with the script to define different shots, selecting assets to be re-used and taking direction decisions. The third user is the producer 120 who mainly interacts with the director 130 to discuss decisions and to make changes. The fourth user is a CGI artist 140 whose role is to work on specific production tasks.

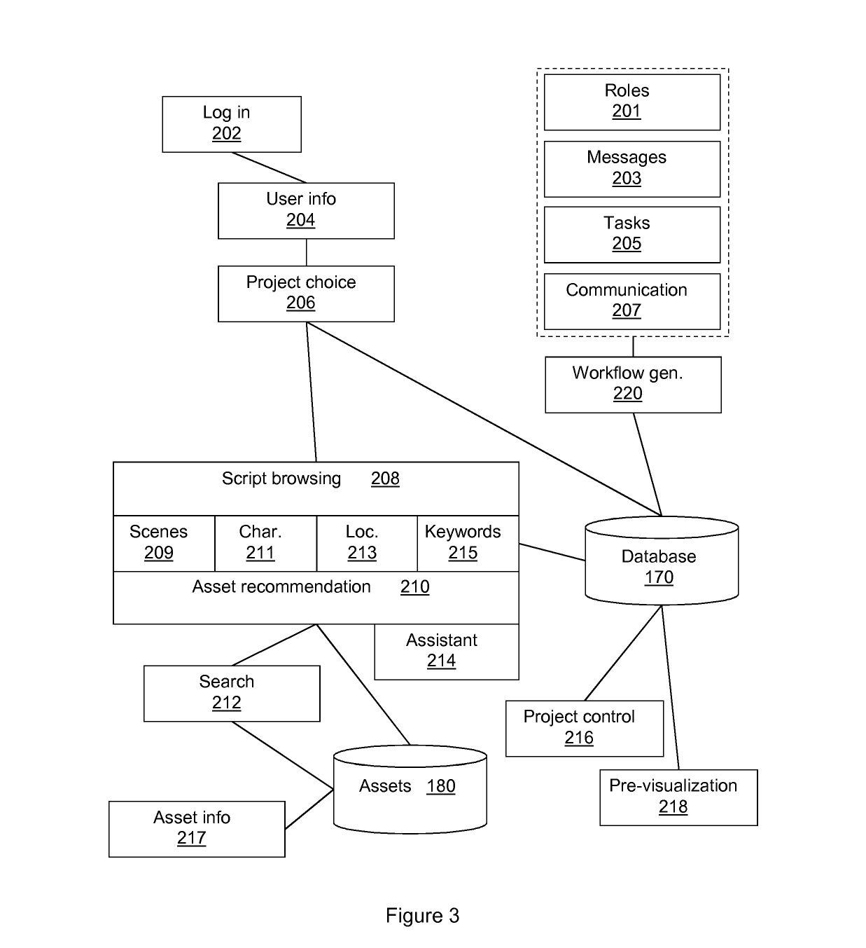

FIG. 3 illustrates the features of the tool 100 required to handle the following exemplary use case in which the steps occur one after another:
1. The director 130 logs on 202 to the tool 100 through the web browser 150 on a laptop, obtains relevant user information 204, visualizes a task list 205 and messages 203. The director selects project “MY_FIRST_HORROR_MOVIE” 206, browses the script 208. The script has been previously processed by identifying keywords and associated categories. For example “Eiffel tower” is identified as a keyword and associated to a “location” category. The director decides to work on scene n° 42, 209 (but could also have worked with characters 211, locations 213 or keywords 215 or to display a list of these). The director looks for assets 210 for this scene by performing asset searches 212 related to the keywords of the scene. This can be done manually: the director selects a keyword and launches an asset search related to this keyword. It can also be done automatically for some or all the keywords of the script. In this case multiple asset searches are launched and their results are displayed when needed. The director selects a set of assets and may display the asset information 217 (e.g. format, quality, duration, price, etc.) related to the selected asset. The director then moves back to the direction phase and uses the direction assistant 214 to make direction choices to define the use of the selected assets.
2. The producer logs in 202, selects the project 206, possibly selects his role 201 (“producer”) in the case he has multiple roles on this project, and uses the pre-visualization tool 218 to see the progress, but does not agree with the choices made for scene n° 17 as it is cheaper to use a video or CGI background rather than the more expensive live shooting planned by the director. The producer then uses the communication tool 207 to communicate with director (using chat, videoconference, phone call, email . . . ). They browse through the assets 210 together to find a possible solution, but as no asset fits their needs they decide to use a new CGI image that should be created especially for this background. The producer modifies 208 the scene accordingly, requesting 216 the creation of the new asset (i.e. the CGI image) and may help in the creation thereof by for example providing a descriptive text about the asset as well as examples in the form of pictures or video. The director finally verifies that the task for the CGI image was created in the task list and updates the production workflow 220 by assigning the 3D modeling task to a team member with the appropriate availability and skill, to with the CGI artist.
3. The director receives a notification 203 that scene n° 17 has been modified and opens the direction page 214 for the scene n° 17 directly from the notification to see the modification done by the producer.
4. The CGI artist, possibly after having received an email, logs in 202 and visualizes his task list 205 and messages 203 and there is indeed a new task: creation of the CGI image for scene n° 17. The CGI artist launches the task of background modeling (possibly using a preferred tool from which the asset can be uploaded to the tool) for the scene, models the asset and, when completed, signals the task as done.
5. The director then receives a notification 203 that this production task has been completed and awaits validation. From the notification, the director opens the created asset 210 and validates it. The task state and asset become approved, and a notification 203 is sent to the CGI artist.

As can be seen, the asset recommendation tool and the direction assistant can aid the director and the producer to make direction and budget choices. In particular, the director can be able to make the film faster and cheaper owing to the reuse of assets and the direction assistant can propose alternatives direction choices, so that more focus can be put on the most important scenes and that in addition can prove useful for beginners. Through the tool, the director can define the vision for each scene, share this with the producer and the parties in charge of making the scenes, and have a rough preview of the movie project at any stage. The producer is able to control the progress continuously and is also able to encourage the director to maximize the reuse of assets to reduce the cost and to enable an earlier release date. All participants in the project benefit from the tool by having a better knowledge of the project and what they are expected to do. This could allow producer to work with less experienced—and thus cheaper and more available—directors that are assisted by the proposed tool. In order to achieve this, it is preferred that easy access to recommended assets is available, for example by displaying a selected asset when its alias appears in the script (or elsewhere in the tool), either automatically or, advantageously, when a user somehow selects the alias (e.g. by putting a cursor over it); such a display can be made in a pop-up window or in a dedicated display area in the tool.

A further advantage is that the tool could lead to the emergence of a marketplace for freelance, remote workers since the tool enables easy access to all the information needed to perform their job.

Relevant parts of the functionality illustrated in FIG. 2 will now be described in greater detail:

### Script Browsing 218:

The user can browse through the script in different ways, such as:
by scene 209: scene by scene navigation. Previously tagged keywords can be highlighted and selected.
by character 211: shows a list of all the characters. When a character is selected, additional information is displayed: type CGI/Real actor, pictures, list of scenes in which the character is involved, etc.
by location 213: shows a list of all the locations. When a location is chosen, additional information is displayed: description, address, pictures, GPS position, list of all scenes where this location is used, etc.
by keyword 215: shows a list of defined keywords. When a keyword is chosen, a list of all the scenes, characters, locations, etc. related to the keyword is returned.
   The keywords entered previously in a script editor are visually differentiated and their type/category is shown. Characters and locations are specific types of keywords.
   The script browser also allows the user, having the requisite access rights, to add new keywords and make modifications to the script, for example by changing a location. For example the “location” keyword “Rennes” can be replaced by “Saint Malo”. All users involved in a task where the location “Rennes” was mentioned are notified of the change. It will be appreciated that it in this case can be necessary to change the anchor linked to the alias “Rennes” so that the tool searches for assets related to “Saint Malo” instead of “Rennes”.

### Asset Search 212:

Using search terms such as keywords, the user can search for assets. The asset recommendation tool 210 can provide possible parameter choices for the search. Apart from keywords, the search terms can include variables deduced by the tool; for example, for a very brief location shot, the tool can deduce that there is no need for much longer assets and automatically add time variable (“<10 s”). The tool can also perform other functions to deduce the variables; for example a search for location shots of “Saint Malo” may be extended to other seaside towns in Brittany, and it is also possible to deduce that if most scenes have their location in Brittany and the next scene, according to the script, has no specific associated setting, then it is probable that the setting for the scene is in Brittany as well and the variable “Brittany” may be added to the search terms.
Each asset is extended by a set of metadata. Some of them were previously associated to the asset, some are added manually and some are calculated automatically during the asset ingest. Metadata can be of various kinds. A first kind of metadata are the set of keywords related to the asset. In the example of the asset representing a video sequence of a seagull on the beach, we could have “Saint Malo” as “location”, “France” as “country”, but also various keywords like “seagull”, “bird”, “sea”, “beach”, “Brittany”, “wind”, “sun”, etc. Other metadata can be extracted from the data itself. For example, duration “10 seconds”, quality “HD”, format “AVI”, codec “H264”, as well as the date of creation and the file size.

### Search Result:

A search results in a set of matching assets, preferably displayed graphically. The user can browse through this set of assets and sort them according the different parameters (e.g.: prices sorting from cheapest to most expensive). The set of assets may also be pre-sorted into categories, e.g. 4 k video, shorter than 5 seconds, at a price lower than 100 [symbol] . Additional asset information and a full resolution pre-visualization are preferably available to help the user verify the quality of the asset. The user may then ‘preselect’ one or more assets as option, thereby forming an “asset cloud” associated with the keyword. The asset cloud, which may be organized in clusters, does not constitute the final choice for the keyword but is associated with it.
The assets may also be searched by affinity or similarity to given references. These references may themselves be external references, or assets previously identified as option for another scene. The goal is to improve the coherence of assets throughout the film.

### Direction Assistant 214:

As already described, the direction assistant may provide direction suggestions based on a set of predefined direction choices. Another possibility is that once preselected assets have been selected for different elements of a given scene, the director may then decide how to combine them and make the final choice of asset(s). First, one or several shots are added to the scene. For each shot, the type of direction is chosen. Then the director can display the asset cloud and assign assets to elements of the shot (e.g. background image).
Many parameters can be fine-tuned to further define each shot, such as for example shot duration, camera lenses and type of shot (close-up, long shot, over the shoulder, etc.). In the general case, the different characters can be ‘represented’ on the screen by photos, drawings, generic dummies . . . . In the case of CGI assets, the position and scale may be modified.
Some assets may need further work, for example colour correction, cropping, blurring, etc. In other cases, no asset is satisfying so a new asset has to be created. This can be specified at this stage by creating and assigning new tasks related to existing assets or assets to be created.
For each shot, a cost and delay estimation may be provided, based on all data provided for the shot and the information in the database mentioned hereinbefore. It will be appreciated that it is advantageous to allow copy-paste, as scenes and shots may have many features in common.

### Pre-Visualization 218:

This features provides the possibility to pre-visualize the project. For the pre-visualization, the tool automatically assembles the assets chosen for each element of the movie, as they have been defined in the direction choice phase. Each scene can be played back one after the other. When a scene is not defined, the corresponding script, which is the simplest version of the movie, can be shown, but it is also possible to render the dialogs through a Text-to-speech engine and simple graphical representations of the participating characters can be overlaid.

It will be understood that variants and extensions of the tool described are possible. For example, the director may select an asset that needs to be “tuned” as it includes an undesired element, such as a modern car in a landscape shot that is intended for a costume drama. The director can then create a new task for digitally removing the car from the asset, and assign the task to a suitable project member, much as the director did assigning a task to the CGI artist in the exemplary use case.

In addition, it has already been briefly described how assets are tagged using keywords. A production company that has finished a project may tag unused assets it created but did not use and upload them to the asset database. Additional parameters can be extracted from these assets—e.g. time of day, direction of lighting and camera movements—and added to the asset metadata.

It is further possible for a production company to create assets intended directly for the asset database. Such creation may for example be done using a multi-camera rig that allows simultaneous recording of different viewing angles and the resulting video can later be used to generate video corresponding to other viewing angles than the ones that were shot.

### Asset Search Parameters.

The following list shows exemplary search types, with some exemplary values, terms that may be used in asset searches:
type of asset: video, image, sound, 3D object, animation motion capture, VFX, filter
quality (depending on type of asset):
   digital value: 1920×1080 pixels, 3M polygons,
   preset values: SD, HD, 4K
   relative: low, medium, high
compositing purpose:
   background
   foreground
   middleground
   isolated element
camera parameters:
   Point of view or Field of view (position of horizon)
   PAN: static, shift, rotation
   Lens
   camera model
format
duration
ambiance/mood
   comic, mysterious, neutral, action, . . .
price
lighting
   contrast
   orientation
   intensity
colors
   color histogram
texture

### Direction Choices.

The following list shows exemplary direction choices for the scenes/shots:
video
   live shooting
   live shooting on greenscreen background
      background asset can either be image, video, static CGI or animated CGI
   live shooting on greenscreen background with foreground
      background asset can be image, video, static CGI or animated CGI
      foreground asset can be image, video, static CGI or animated CGI
   multilayer composition
      each layer can be image, video, static CGI or animated CGI, either as existing assets or as new ones (requires shooting for the video).
   pure animation
audio
   onset live recording
   mix
      onset live recording
      studio recording/dubbing
      sound effects
      music
Necessary postproduction tasks:
   Video or image asset editing
      cropping/reframing or cut
      recolorization
      inpainting
      rotoscoping
      adaptation of asset length to scene duration (by repetition, mirroring, shrinking . . . )
      depth map drafting for further 3D asset insertion
   3D asset editing
      VFX
      remodeling
      recolorization
   Motion capture asset editing
      animation retuning
   Adaptation of motion capture length to scene duration/real footage (e.g. footage shot for the need of the project)
      Possibly the same as for ‘video’

It will be appreciated that the tool is best implemented using the required hardware and software components, such as processors, memory, user interfaces, communication interfaces and so on. How this is done is well within the capabilities of the skilled person. As an example, the users' browsers are advantageously implemented on the users' existing computers or tablets, while the databases can be implemented on any suitable prior art database and the server on any suitable prior art server.

The skilled person will appreciate that the present invention can provide a tool for efficient collaborative pre-production.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1. An asset handling tool for pre-production of a film having a script, the asset handling tool being implemented using at least one processor configured to:
obtain an expression from a scene of the script;
send to an asset database a query for assets corresponding to the expression;
receive a set of assets matching the expression;
display at least part of the set of assets to a user;
receive, from the user, a selection of an asset in the set of assets; and
link the selected asset with the expression.

2. The asset handling tool of claim 1, wherein the processor is configured to link the selected asset and the expression indirectly by associating the expression with an anchor, the anchor being liable to be linked with a plurality of expressions, and by associating the anchor with the selected asset.

3. The asset handling tool of claim 2, wherein the processor is further configured to split an anchor associated with a plurality of expressions into two anchors, each associated with a subset of these expressions,

4. The asset handling tool of claim 1, wherein the processor is further configured to analyze the script for the scene to extract information and to include the extracted information in the query; wherein the information comprises at least one of: location information, context information, and a variable deduced from the script, the deduced variable comprising the length of a scene.

5. The asset handling tool of claim 4, wherein the processor is further configured to analyze assets already associated with an anchor to deduce common information and to include the common information in the query.

6. The asset handling tool of claim 4, wherein the processor is further configured to analyze expressions already associated with an anchor to deduce common information and to include the common information in the query.

7. The asset handling tool of claim 1, wherein the selection received from the user is for a plurality of assets.

8. The asset handling tool of claim 1, wherein the processor is further configured to include information on already chosen assets and indicate that the query is for assets similar to the chosen assets.

9. The asset handling tool of claim 1, wherein the processor is further configured to include asset parameters in the query, the asset parameters comprising at least one of: type of asset, quality, compositing purpose, camera parameters, format, duration, ambiance or mood, price, lighting, colours colors and texture.

10. The asset handling tool of claim 1, wherein the processor is further configured to display an asset when its corresponding expression is displayed to the user.

11. The asset handling tool of claim 10, wherein the processor is further configured to display an asset only when its corresponding expression has been selected by the user.
